(19) United States
(12) Patent Application Publication
(10) Pub. No.: US 2015/0336575 A1
(43) Pub. Date: Nov. 26, 2015

(54) COLLISION AVOIDANCE WITH STATIC TARGETS IN NARROW SPACES

(71) Applicant: GM GLOBAL TECHNOLOGY OPERATIONS LLC, DETROIT, MI (US)

(72) Inventor: SHUQING ZENG, STERLING HEIGHTS, MI (US)

(73) Assignee: GM GLOBAL TECHNOLOGY OPERATIONS LLC, DETROIT, MI (US)

(21) Appl. No.: 14/283,486

(22) Filed: May 21, 2014

(51) Int. Cl. B60W 30/09; B62D 15/02; B60T 7/22

(52) U.S. Cl. CPC B60W 30/09; B60T 7/22; B62D 15/0265; B60W 2550/10

(57) ABSTRACT

A method of detecting and tracking objects for a vehicle traveling in a narrow space. Estimating a host vehicle motion of travel. Objects exterior of the vehicle are detected utilizing object sensing devices. A determination is made whether the object is a stationary object. A static obstacle map is generated in response to the detection of the stationary object detected. A local obstacle map is constructed utilizing the static obstacle map. A pose of the host vehicle is estimated relative to obstacles within the local obstacle map. The local object map is fused on a vehicle coordinate grid. Threat analysis is performed between the moving vehicle and identified objects. A collision prevention device is actuated in response to a collision threat detected.

### BACKGROUND OF INVENTION

An embodiment relates to collision avoidance warning systems.

Radar systems are also used to detect objects within the road of travel. Such systems utilize continuous or periodic tracking of objects over time to determine various parameters of an object. Often times, data such as object location, range, and range rate are computed using the data from radar systems. However, inputs from radars are often sparse tracked targets. Park assist in narrow spaces such as parking garages may not provide accurate or precise obstacle information due to its coarse resolution. Moreover, once an object is out of the view of the current sensing device, collision alert systems may not be able to detect the object as the object is no longer tracked and will not be considered a potential threat.

### SUMMARY OF INVENTION

An advantage of an embodiment is a detection of potential collision with objects that are outside of a field-of-view of a sensed field. A vehicle when traveling in a confined space utilizing only a single object sending device stores previously sensed objects in a memory and maintains those objects in the memory while a vehicle is maintained with a respective region. The system constructs a local obstacle map and determines potential collisions with the sensed objects currently in the field-of-view and objects no longer in the current field-of-view of the sensing device. Therefore, as the vehicle transitions through the confined space where sensed objects are continuously moving in and out of the sensed field due to the vehicles close proximity to the objects, such objects are maintained in memory for determining potential collisions even though the objects are not currently being sensed by the sensing device.

An embodiment contemplates a method of detecting and tracking objects for a vehicle traveling in a narrow space. Estimating a host vehicle motion of travel. Objects exterior of the vehicle are detected utilizing object sensing devices. A determination is made whether the object is a stationary object. A static obstacle map is generated in response to the detection of the stationary object detected. A local obstacle map is constructed utilizing the static obstacle map. A pose of the host vehicle is estimated relative to obstacles within the local obstacle map. The local object map is fused on a vehicle coordinate grid. Threat analysis is performed between the moving vehicle and identified objects. A collision prevention device is actuated in response to a collision threat detected.

### BRIEF DESCRIPTION OF DRAWINGS

FIG. 1 is a pictorial of a vehicle incorporating a collision detection and avoidance system.

FIG. 2 is a block diagram of a collision detection and avoidance system.

FIG. 3 is a flowchart of a method for determining collision threat analysis.

FIG. 4 is an exemplary illustration of detected objects by an object detection device.

FIG. 5 is an exemplary illustration of sensed data over time for determining rigid transformation.

FIG. 6 is an exemplary local obstacle map based on a vehicle coordinate grid system.

FIG. 7 is an exemplary illustration of a comparison between a previous local obstacle map and a subsequent local obstacle map.

### DETAILED DESCRIPTION

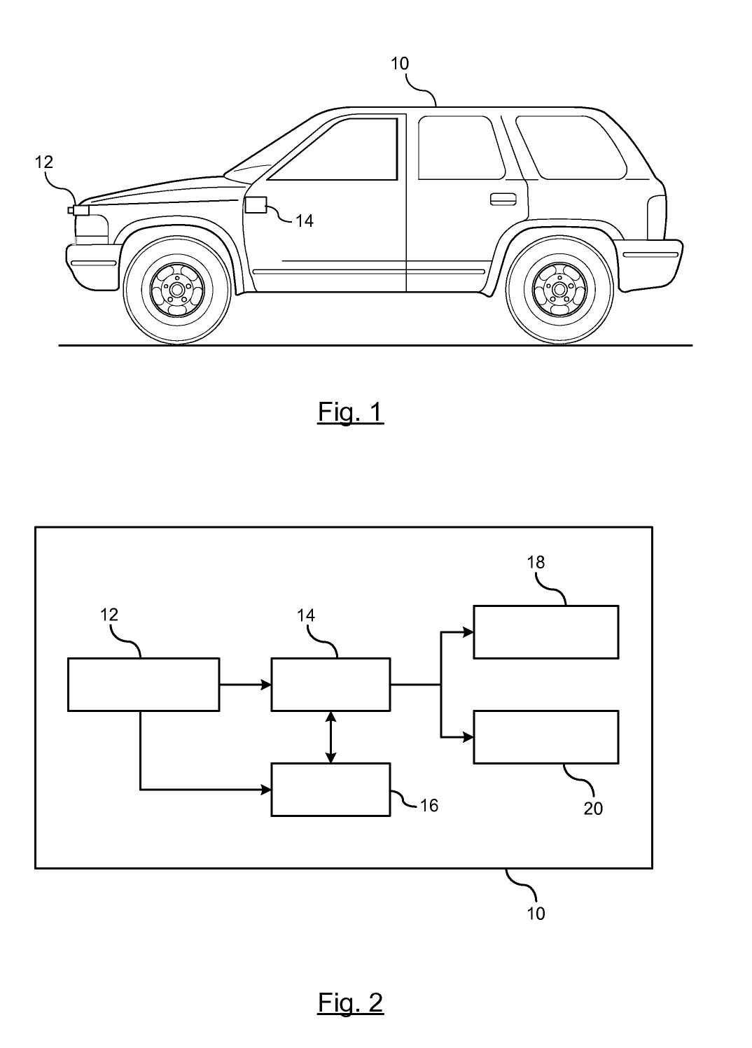

FIG. 1 a vehicle 10 equipped with a collision avoidance detection system. The collision avoidance detection system includes at least one sensing device 12 for detecting objects exterior of the vehicle. The at least one sensing device 12 is preferably a Lidar sensing device directed in a direction forward of the vehicle. Alternatively, the at least one sensing device 12 may include synthetic aperture radar sensors, RF-based sensing devices, ultrasonic sensing devices, or other range sensing devices. The at least one sensing device 12 provides object detection data to a processing unit 14 such as a collision detection module. The processing unit 14 generates a local obstacle map for a respective region surrounding the vehicle. Based on the detected objects within the region, the processing unit determines whether there is a potential for collision with objects surrounding the vehicle that are both within the field-of-view as well as outside of the field-of-view of the object detection devices. The processing unit 14 then either generates a warning signal to the driver or data is sent to an output device for mitigating the potential collision.

FIG. 2 illustrates a block diagram of the various devices required for determining a potential collision as described herein. The vehicle 10 includes the at least one sensing device 12 that is in communication with the processing unit 14. The processing unit 14 includes a memory 16 for storing data relating to the sensed objects obtained by the at least one sensing device 12. The memory 16 is preferably random access memory; however, alternatively forms of memory may be used such as a dedicated hard drive or shared hard drive memory. The processing unit 14 can access the stored data for generating and updating the local obstacle map.

The processing unit 14 is also in communication with an output device 18 such as a warning device for warning the driver directly of a potential collision. The output device 18 may include a visual warning, an audible warning, or a haptic warning. The warning to the driver may be actuated when a determination is made the collision is probable and the collision will occur in less than a predetermined amount of time (e.g., 2 seconds). The time should be based on the speed that the driver is driving and the distance to an object so as to allow the driver to be warned and take the necessary action to avoid the collision in the allocated time.

The processing unit 14 may further be in communication with a vehicle application 20 that may further enhance the collision threat assessment or may be a system or device for mitigating a potential collision. Such systems may include an autonomous braking system for automatically applying a braking force to stop the vehicle. Another system may include a steering assist system where a steering torque is autonomously applied to a steering mechanism of the vehicle for mitigating the collision threat. Actuation of a system for mitigating the collision when a determination is made the collision is probable and the collision will occur in less than a predetermined amount of time (e.g., 0.75 seconds). The time should be based on the speed that the driver is driving and the distance to an object so as to allow the system to actuate the mitigation devices to avoid the collision in the allocated time.

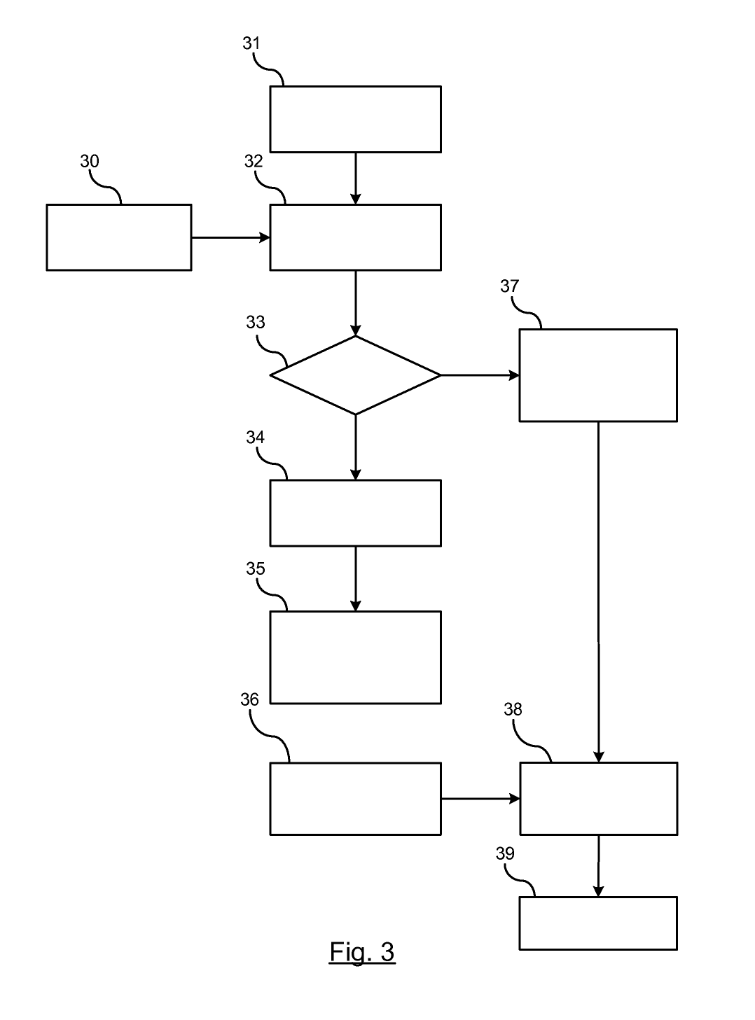

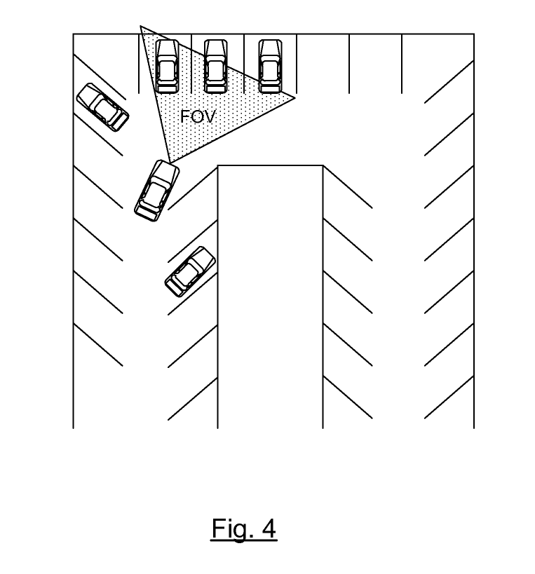

FIG. 3 illustrates a flow chart for determining a threat analysis by utilizing a generated local obstacle map.

In block 30, a motion of the vehicle traveling in a confined space such as a parking structure is estimated. The vehicle hereinafter is referred as the host vehicle which includes the object detection device for detecting obstacles exterior of the vehicle.

In block 31, object detection devices such as Lidar or SAR radar detects objects in a field-of-view (FOV). The FOV is the sensing field generated by the object detection devices. Preferably, the object detection devices are directed in a forward facing direction relative to the vehicle. FIG. 4 illustrates a vehicle traveling through a narrow space such as a parking structure utilizing a front Lidar only sensing device to sense objects therein. As shown in FIG. 4, only a respective region, designated generally by the FOV, is sensed for objects. As a result, when traveling through the parking structure, a FOV may change constantly being that the vehicle is continuously passing parked vehicles and structure the parking facility as it travels on the ramps of the parking facility.

The Lidar sensing device is mounted on the host vehicle, which is a moving platform. A target region (FOV) is repeatedly illuminated with a laser and the reflections are measured. The waveforms are successively received at the various antenna positions as a result of the host vehicle moving. Such positions are coherently detected, stored, and cooperatively processed to detect objects in the image of the target region. It should be understood that each received waveform corresponds to a radar point as opposed to the entire object. Therefore, a plurality of waveforms is received representing different radar points as opposed to the entire object. Therefore, the various radar points may relate to a single object or distinct objects. The results generated in block 30 (estimated vehicle motion) and block 31 (detected objects) are input to a scene analysis and classification module.

In block 32, the scene analysis and classification module analyzes the data generated in blocks 30 and 31 for detecting an object in the scene and classifying what the object is based on trained classifier. In block 32, a determination must be made as to whether a set of points are within a same cluster. To do so, any clustering technique may be utilized. The following is an example of one clustering technique that may be used. All points detected from the Lidar data are initially treated as separate clusters. Each point is a 3-D point in space (x, y, v) where x is a latitude coordinate relative to the host vehicle, y is a longitudinal coordinate relative to the host vehicle, and v is a velocity information relative to the host vehicle.

Secondly, each point is compared to its neighboring point. If a similarity metric between a respective point and its neighbor is less than a similarity threshold, then the two points are merged into a single cluster. If the similarity metric is greater than a similarity threshold, then the two points remain separate clusters. As a result, one or more clusters are formed for each of the detected points.

In block 33, a determination is made whether the object is a static object (i.e., stationary) or whether the object is a dynamic (i.e., moving) object. If the determination is made that the object is a static object, then the routine advances to block 34; otherwise, the routine proceeds to block 37. Various techniques may be used to determine whether the object is a static object or a dynamic object without deviating from the scope of the invention.

In block 34, the object is added to a static obstacle map for a respective time frame. Therefore, a respective static obstacle map is generated for each time frame.

In block 35, a local obstacle map is constructed as a function of each of the respective obstacle maps generated for each time frame. The local obstacle is based on an estimated host vehicle pose.

The pose of the host vehicle may be determined as follows. Given the following inputs, a local obstacle model M, current scan S for static obstacles at time (t), and a prior host vehicle pose v⁽⁰⁾=v(t−1) at time t−1, the system determines the updated vehicle pose v(t). Thereafter, the vehicle pose is iteratively computed until convergence is obtained. Convergence occurs when two subsequent pose computations are substantially equal. This is represented by the following formula:

p(t)=p⁽ⁿ⁺¹⁾. (1)

The vehicle pose at the next time step can be determined using the following formula:

$${p}^{( n + 1 )} = aeg {min}_{{p}^{( n )}} {\sum }_{j , k} {\tilde{A}}_{jk} ( \frac{{‖ {s}_{j} - {T}_{p ( n )} ( {m}_{k} ) ‖}^{2}}{{σ}^{2}} ) \qquad ( 2 )$$

where sⱼ is a scan point, mₖ is a model point, Tᵥ(x) is an operator to apply rigid transformation v during Δt for a point x, and Âⱼₖ is a computed weight denoted as a probability, and the scan point sⱼ is a measurement of mode point mₖ, which can be computed as:

$${\hat{A}}_{jk} = \frac{exp ( - \frac{{‖ {s}_{j} - {T}_{p ( n )} ( {m}_{k} ) ‖}^{2}}{{σ}^{2}} )}{{\sum }_{k} exp ( - \frac{{‖ {s}_{j} - {T}_{p ( n )} ( {m}_{k} ) ‖}^{2}}{{σ}^{2} } )} .$$

To construct the local obstacle map, the obstacle model M is modeled as a Gaussian mixture model as follows:

$$\begin{matrix}p ( x ; M ) = {\sum }_{k = 1}^{{n}_{M}} \frac{1}{{n}_{M}} p ( x \vert {m}_{k} ) & ( 3 ) \\ p ( x ; {m}_{k} ) = \frac{1}{{( 2 π {σ}^{2} )}^{\frac{3}{2}}} exp ( - \frac{{‖ x - {m}_{k} ‖}^{2}}{2 {σ}^{2}} ) & ( 4 )\end{matrix}$$

The prior distribution of the mean is Gaussian distribution, i.e.,

$$p ( {m}_{k} ) = N ( {v}_{k} , \frac{{σ}^{2}}{{η}_{k}} ) \qquad ( 5 )$$

where vₖ and ηₖ are parameters.

The parameter mₖ is distributed as ρₖ=ΣⱼÂⱼₖ, s̅ₖ=ΣⱼÂⱼₖsⱼ/ρₖ and the equations for updating parameters vₖ and ηₖ are as follows:

$$\begin{matrix}{v}_{k}^{′} = \frac{{ρ}_{k} {\overline{s}}_{k} + {η}_{k} {T}_{{y}_{t + 1}} ( {v}_{k} )}{{ρ}_{k} + {η}_{k}} & ( 6 ) \\ {η}_{k}^{′} = {η}_{k} + {ρ}_{k} . & ( 7 )\end{matrix}$$

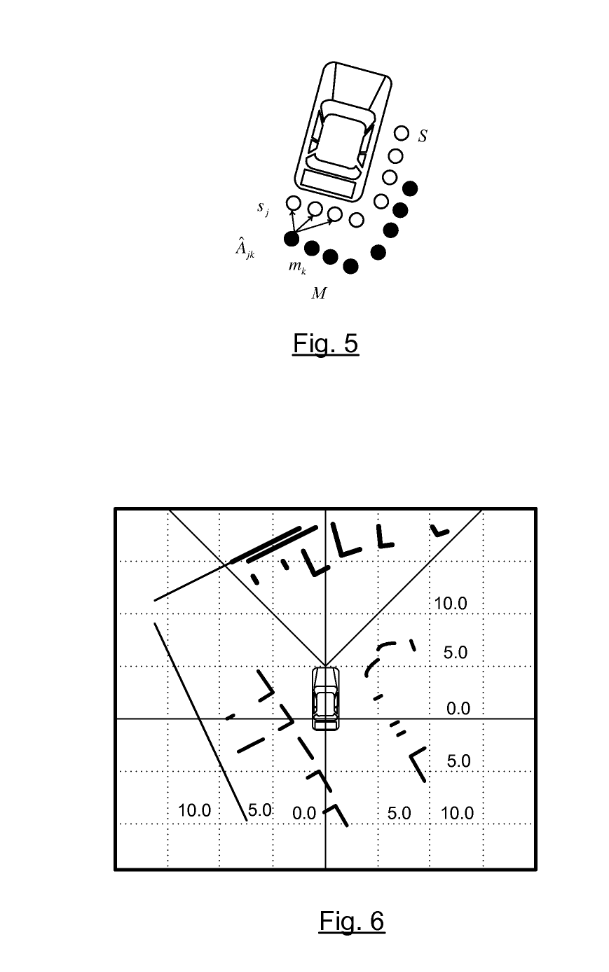

As a result, a rigid transformation can be solved for between the scan S and the local obstacle model M. FIG. 5 illustrates an exemplary illustration of Lidar data traced over time for a vehicle for a determination of a rigid transformation where a set of points is detected for a cluster at a previous instance of time (M) and a set of points is detected for a cluster at a current instance of time (S). Given the input of object model M based on the previous radar map, a current radar map S, and a prior rigid motion determination v from M to S, a current rigid motion v is determined. Rigid transformation is used to cooperatively verify a location and orientation of objects detected by the radar devices between two instances of time. That is, scans of adjacent frames are accumulated and the probability distribution of an obstacle model is computed. As a result, orientation of the vehicle using the plurality of tracking points allows the vehicle position and orientation to be accurately tracked.

Based on the scans of the environment surrounding the vehicle, an obstacle map is generated. The local obstacle map is preferably generated as a circular region surrounding the vehicle. For example, the distance may be a predetermined radius from the vehicle including, but not limited to 50 meters. Utilizing a 2-dimensional (2D) obstacle map, the origin is identified as a reference point, which is designated as the location of the center of gravity point of the host vehicle. The obstacle map therefore is represented by a list of points where each point is a 2D Gaussian distribution point representing a mean having a variance σ².

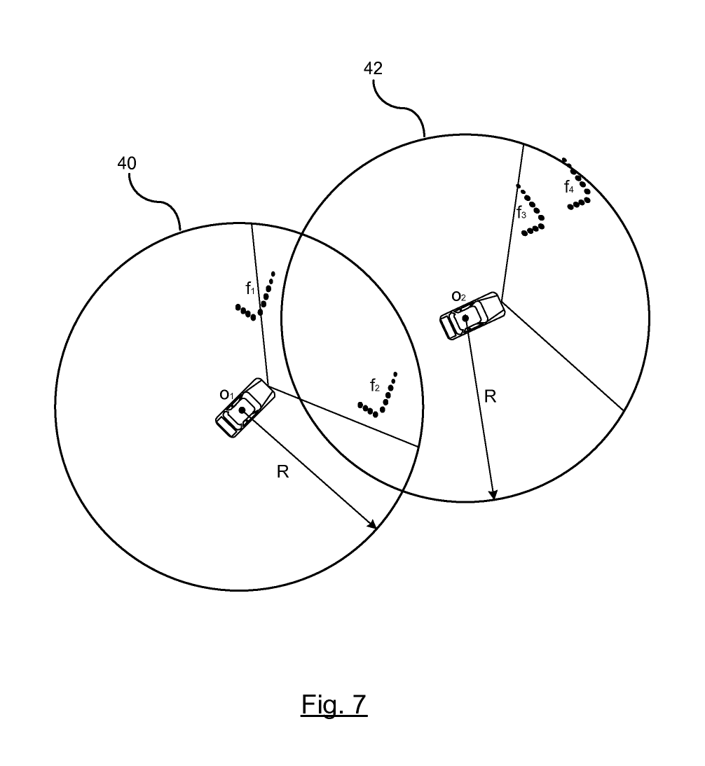

FIG. 6 represents a local obstacle map for a respective location where the static objects are inserted therein based on a global vehicle coordinate grid system. An exemplary grid system is shown mapped as part of the local obstacle map. The host vehicle is shown at the center of the local obstacle map (i.e., origin) along with the FOV sensed region generated by the Lidar sensing device. Static objects are shown within the current FOV as well as static objects outside of the current FOV surrounding the vehicle. Static objects outside of the current FOV are detected at a previous time and are maintained in the memory until the vehicle has traveled a predetermined distance (e.g., 50 meters) from the origin. Once the vehicle reaches the predetermined distance from the origin, a subsequent obstacle map will be generated as illustrated in FIG. 7. The location at which the vehicle reaches the predetermined distance from the current origin will thereafter be identified as the subsequent origin used to generate the subsequent obstacle map. All static objects currently detected or previously detected that are within the predetermined range (e.g., 50 meters) of the subsequent origin will be incorporated as part of the subsequent local obstacle map. Obstacle points in the current map are transformed to the new coordinate map frame. Those obstacle points outside of the predetermined distance of the subsequent obstacle map are removed. As new obstacle points when visible to the host vehicle are detected by the Lidar detecting device, such points are added to the subsequent obstacle map. A new vehicle pose relative to static objects are identified. As a result, subsequent maps are continuously generated when the vehicle reaches the predetermined distance from the origin of the currently utilized obstacle map and objects are added and removed depending on whether objects are within or outside of the predetermined range.

In FIG. 7, a first obstacle map 40 is generated having an origin O₁ and detected static objects f₁ and f₂. Objects f₁ and f₂ are within the predetermined range R from O₁, and are therefore, incorporated as part of the first local obstacle map O₁. As the vehicle travels beyond the predetermined range from the origin O₁, a subsequent local obstacle map 42 is generated having an origin O₂. The subsequent local obstacle map 42 will be defined by a region having a radius equal to the predetermined range from origin O₂. As shown in the subsequent local obstacle map 42, newly detected objects include f₃ and f₄. As is also shown, object f₂ is still within the predetermined range of origin O₂, so object f₂ will be maintained in the subsequent local obstacle map even though object f₂ is not in a current FOV of the Lidar sensing device. However, object f₁ is outside of the predetermined range of origin O₂, so this object will be deleted from the map and memory.

Referring again to block 38 in FIG. 2, the local map is input to a collision threat detection module for detecting potential threats with regards to static objects. If a potential threat is detected in block 38, then an output signal is applied to an output device at block 39. In block 39, the output device may be used to notify the driver of the potential collision, or the output device may be system/device for mitigating a potential collision. Such systems may include an autonomous braking system for automatically applying a braking force to prevent the collision. Another system may include a steering assist system where a steering torque is autonomously applied to the steering of the vehicle for mitigating the collision threat.

Referring again to block 33, if a detection is made that the object is a dynamic object such as a moving vehicle or pedestrian, then the object is identified as a dynamic object is block 37. The movement of the dynamic object may be tracked and sensed over time and provided to the collision threat analysis module at block 38 for analyzing a potential collision with respect to the dynamic object. The analyzed data may be applied to the output device in block 39 for providing a warning or mitigating the potential collision with the dynamic object.

While certain embodiments of the present invention have been described in detail, those familiar with the art to which this invention relates will recognize various alternative designs and embodiments for practicing the invention as defined by the following claims

What is claimed is:

1. A method of detecting and tracking objects for a vehicle traveling in a narrow space, the method comprising the steps of:
estimating a host vehicle motion of travel;
detecting objects exterior of the vehicle utilizing object sensing devices;
determining whether the object is a stationary object;
generating a static obstacle map in response to the detection of the stationary object detected ;
constructing a local obstacle map utilizing the static obstacle map;
estimating a pose of the host vehicle relative to obstacles within the local obstacle map;
fusing the local object map on a vehicle coordinate grid;
performing threat analysis between the moving vehicle and identified objects;
actuating a collision prevention device in response to a collision threat detected.

2. The method of claim 3 wherein constructing the local map further includes the steps of:
identifying an origin within the local obstacle map;
identifying an observation region that is constructed by a predetermined radius from the origin; and
identifying static objects with the region.

3. The method of claim 2 wherein the origin is a position relating to location of a center of gravity of the vehicle.

4. The method of claim 2 wherein local obstacle map and the detected static objects are stored within a memory.

5. The method of claim 4 wherein local obstacle map and detected static objects stored in the memory is stored in random access memory.

6. The method of claim 4 wherein the motion of the vehicle is tracked while moving within the region of the local obstacle map for detecting potential collisions with detected static objects.

7. The method of claim 6 further comprising the step of generating a subsequent local obstacle map in response to the vehicle being outside of the region.

8. The method of claim 7 wherein generating a subsequent local obstacle map comprises the steps of:
identifying a location of the vehicle when the vehicle is at a distance equal to the predetermined radius from the origin;
labeling the identified location of the vehicle as a subsequent origin;
identifying a subsequent region that is a predetermined radius from the subsequent origin; and
identifying static objects only within the subsequent region.

9. The method of claim 1 wherein detecting objects exterior of the vehicle utilizing object sensing devices includes detecting the objects using synthetic aperture radar sensors.

10. The method of claim 1 wherein detecting objects exterior of the vehicle utilizing object sensing devices includes detecting the objects using Lidar sensors.

11. The method of claim 1 wherein actuating a collision prevention device includes enabling a warning to the driver of the detected collision threat.

12. The method of claim 1 wherein the warning to the driver of the detected collision threat is actuated in response to a determined time-to-collision being less than 2 seconds.

13. The method of claim 1 wherein actuating a collision prevention device includes actuating an autonomous braking device for preventing a potential collision.

14. The method of claim 1 wherein the autonomous braking device is actuated in response to a determined time-to-collision being less than 0.75 seconds.

15. The method of claim 1 wherein actuating a collision prevention device includes actuating a steering assist device for preventing a potential collision.

16. The method of claim 1 further comprising the steps of:
identifying dynamic objects from the object sensing devices;
estimating a path of travel of the identified dynamic objects;
fusing dynamic objects in the local obstacle map; and
performing a threat analysis including potential collisions between the vehicle and the dynamic object.

17. The method of claim 1 wherein generating a static obstacle map comprises the steps of:
(a) generating a model of the object that includes a set of points forming a cluster;
(b) scanning each point in the cluster;
(c) determining a rigid transformation between the set of points of the model and the set of points of the scanned cluster;
(d) updating the model distribution; and
(e) iteratively repeating steps (b)-(d) for deriving a model distribution until convergence is determined.

18. The method of claim 17 wherein each object is modeled as a Gaussian mixture model.

19. The method of claim 18 wherein each point of a cluster for an object is a represented as a 2-dimensional Gaussian distribution, and wherein each respective point is a mean having a variance σ².
